(19) United States
(12) Patent Application Publication
(10) Pub. No.: US 2014/0285079 A1
(43) Pub. Date: Sep. 25, 2014

(54) VENDING MACHINE WITH DOOR PULL ASSEMBLY

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: SHUAI WU, Wuhan (CN); SHU-QI WU, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/093,115

(22) Filed: Nov. 29, 2013

(30) Foreign Application Priority Data
Mar. 25, 2013 (CN) 2013100963387

(51) Int. Cl. G07F 9/10; E05F 1/00

(52) U.S. Cl. CPC G07F 9/10; E05F 1/00
USPC 312/329; 16/71

(57) ABSTRACT

A vending machine includes a cabinet; a door, a bar, and a puller. The door is rotatable relative to the cabinet. The bar is mounted to the door. The puller includes a cylinder and a rod. The cylinder is fixed to the cabinet. A joint is attached to one end of the rod. The joint is slidable on the bar. The cylinder can draw the rod. The rod can pull the door relative to the cabinet.

### BACKGROUND

1. Technical Field

The disclosure generally relates to vending machines, especially for a vending machine with a door pull assembly.

2. Description of Related Art

A vending machine includes a cabinet and a door. Goods are stored in the cabinet. The door is rotatable relative to the cabinet for protecting the goods in the cabinet. A traditional door is manually opened or closed relative to the cabinet. However, many components, such as a temperature management device, a monitoring device, are assembled in the door. The door is heavy, and it is hard to manually control an opening angle of the door relative to the cabinet. A goods operator may be hurt by the door by accident. There is a room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a vending machine of one embodiment.

FIG. 2 is a cutaway view of vending machine of FIG. 1.

FIG. 3 is an enlarged view of a circled portion III of FIG. 2.

FIG. 4 is an enlarged view of a circled portion IV of FIG. 2.

FIG. 5 is an enlarged view of a circled portion V of FIG. 1.

FIG. 6 is an assembled, cross-sectional, top view of the vending machined of FIG. 1, a door being opened.

FIG. 7 is similar to FIG. 6, but an opening angle of the door 30 being changed.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

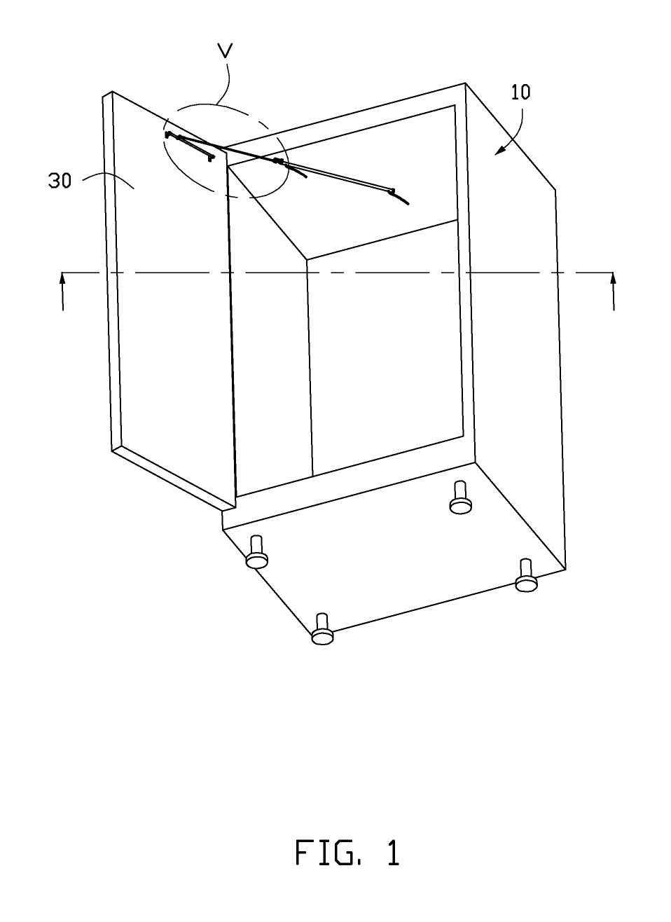

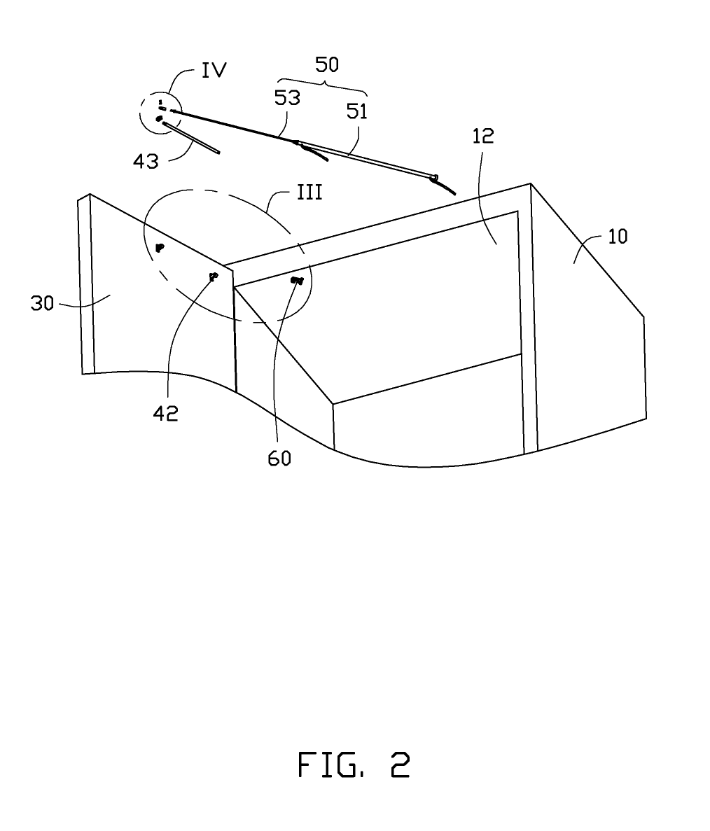

FIG. 1 illustrates one embodiment of a vending machine, and FIG. 2 illustrates an exploded cutaway view of the vending machine. The vending machine includes a cabinet 10, a door 30, and door pull assembly. The door 30 is rotatable relative to the cabinet 10. The door pull assembly includes a bar 43 and a puller 50.

Two bar holders 42 are fixed to the door 30. The bar 43 is fixed to the bar holder 42 at two opposite ends. The bar 43 is spaced relative to the door and is substantially parallel to the door 30.

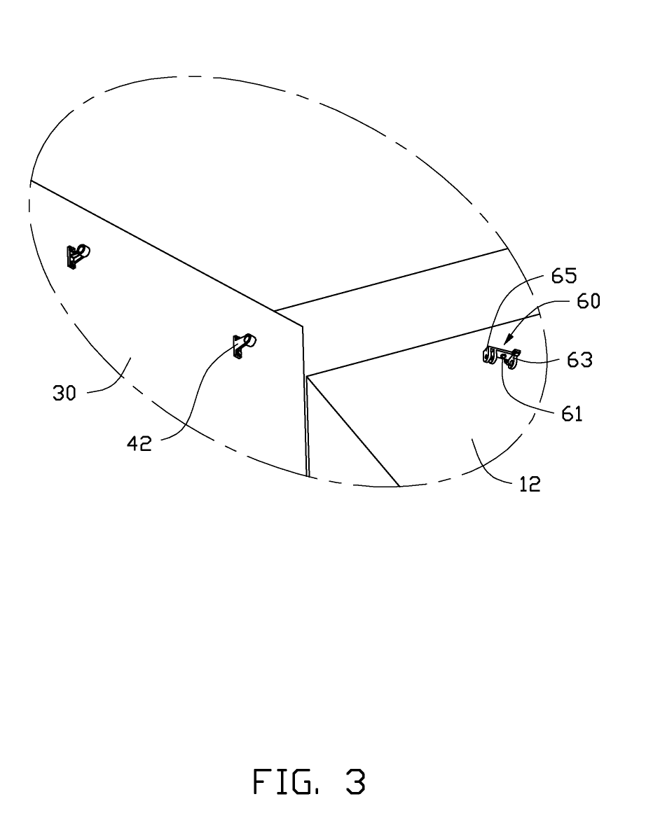

FIG. 3 illustrates an enlarged view of a circled portion III of FIG. 2. The cabinet 10 includes a top wall 12. An extending direction of the bar 42 is substantially parallel to the top wall 12. A connector 60 is fastened to the top wall 12 with a screw 61 and is rotatable relative to the top wall 12 about the screw 61. The connector 60 includes a fixing portion 63 and a locating portion 65.

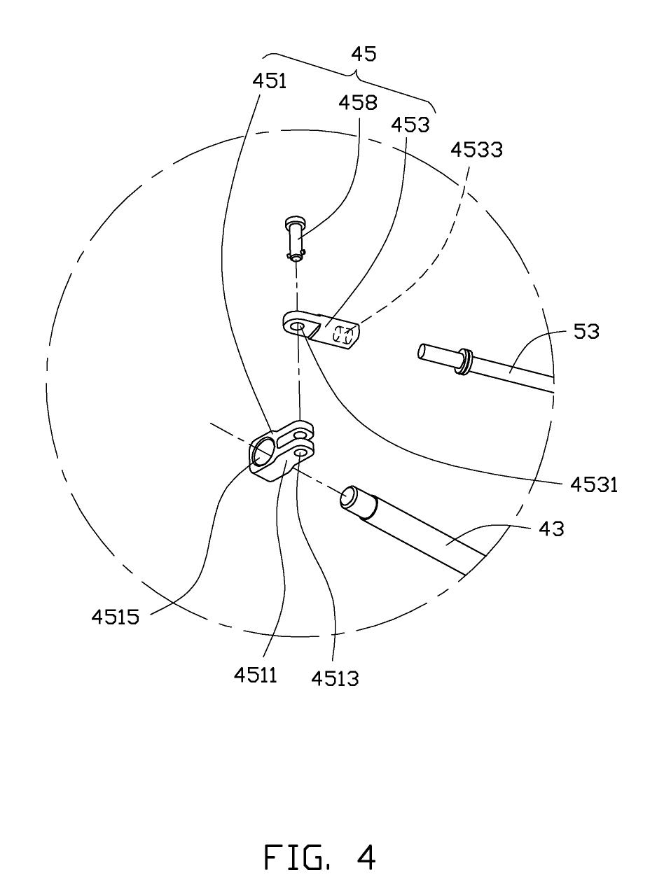

FIG. 4 illustrates an enlarged view of a circled portion IV of FIG. 2. A joint 45 is attached to the bar 43. The joint 54 includes a slider 451, a rotator 453, and a fastener 458. The slider 451 is slidably attached to the bar 43. The rotator 453 pivots relative to the slider 451. The rotator 453 is attached to the slider 451 through the fastener 458, and the rotator 453 pivots about the fastener 458. The slider 451 defines a through hole 5415. The bar 43 extends through the through hole 4515. The slider 451 includes two fixing tabs 4511. The two fixing tabs 4511 are spaced and substantially perpendicular to each other. Each fixing tab 4511 defines a fixing hole 4513. The fastener 4581 extends through the two fixing holes 4513. The rotator 453 includes a securing tab 4531 at a first end and defines a mounting hole 4533 at a second end. The securing tab 4531 is located between the two fixing tabs 4511. In some embodiments, the securing tab 5431 is sandwiched between the two fixing tabs 4511.

The puller 50 includes a cylinder 51 and a rod 53. The cylinder 51 and the rod 53 are fixed to the connector 60, and are located at opposite sides of the connector 60. The cylinder 51 is fixed to the fixing portion 63. The rod 53 extends through the locating portion 65 and is extensive relative to the cylinder 51. The cylinder 51 can pull and push the rod 53 to close or open the door 30 relative to the cabinet 10.

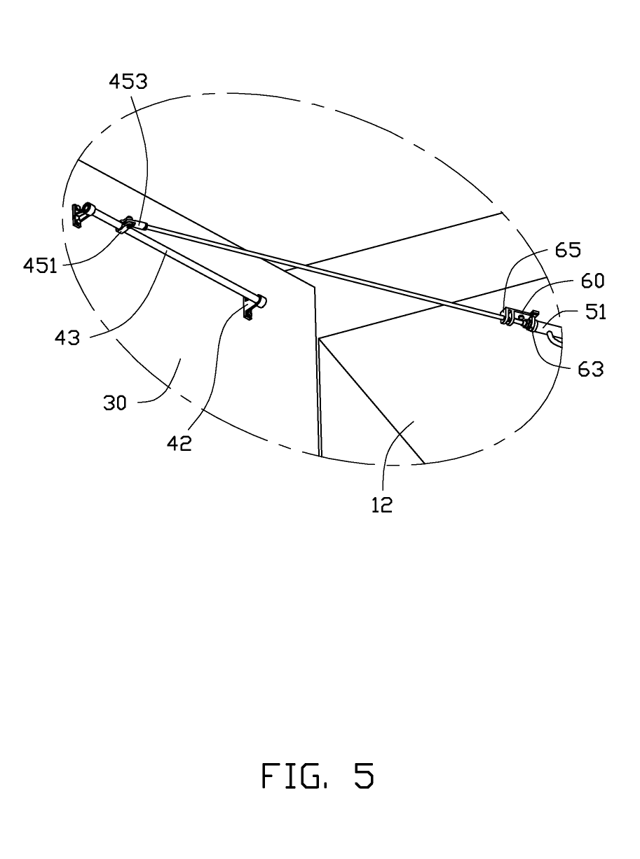

FIG. 5 illustrates an enlarged view of a circled portion V of FIG. 1. In assembly, the joint 45 is attached and slidable on the bar 43. The bar 43 is assembled to the bar holders 42. The cylinder 51 is secured to the connector 60. The rod 53 is extensive relative to the cylinder 51. The rod 53 and the cylinder 51 are mounted to the connector 60. A distal end of the rod 53 is mounted to the mounting hole 4533 of the rotator 453.

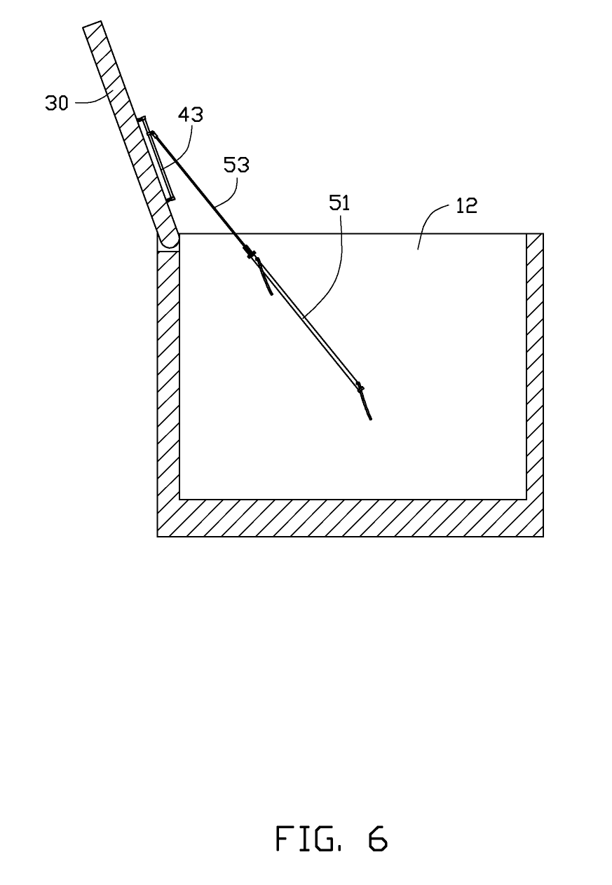

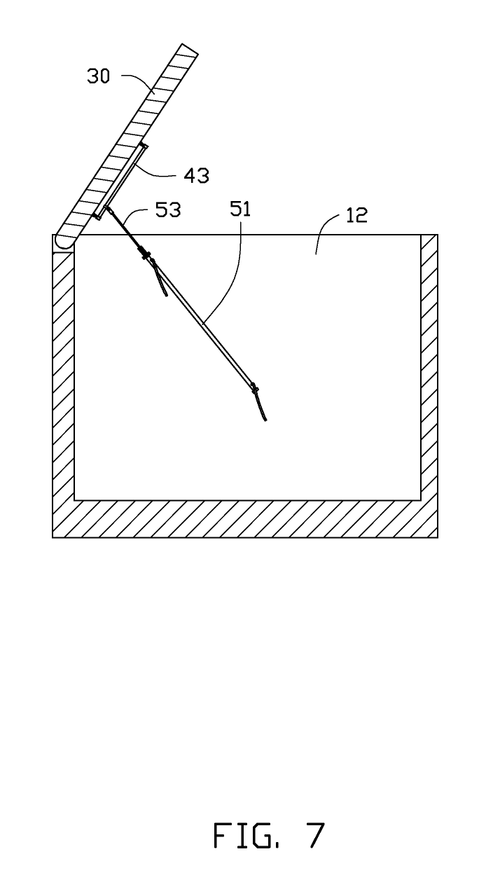

FIG. 6 and FIG. 7 illustrate two states of the door 30 relative to the cabinet 10.

To open the door 30, the cylinder 51 is powered. The cylinder 51 is controlled to push away the rod 53. The rod 53 pushes the bar 43 to open the door 30 relative to the cabinet 10. The door 30 can be stopped at any desired angle. When closing the door 30, the cylinder 51 is controlled to pull the rod 53. The rod 53 draws the bar 43 to close the door 30.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A vending machine, comprising:
a cabinet;
a door rotatable relative to the cabinet;
a bar mounted to the door; and
a puller comprising a cylinder and a rod, the cylinder fixed to the cabinet, a joint attached to one end of the rod, and the joint slidable on the bar,
wherein the cylinder is configured to draw the rod, and the rod is configured to pull the door relative to the cabinet.

2. The vending machine of claim 1, wherein the joint comprises a slider and a rotator, the slider is slidably attached to the bar, the rotator is pivotable relative to the slider, and the rod is mounted to the rotator.

3. The vending machine of claim 2, wherein the rotator is attached to the slider through a fastener, and the rotator is pivotable about the fastener.

4. The vending machine of claim 1, wherein the bar is fixed to the door through two bar holder, and the bar is spaced and substantially parallel to the door.

5. The vending machine of claim 1, wherein a plane defined by the rod and the bar is substantially perpendicular to the door.

6. The vending machine of claim 1, wherein a connector is fixed and rotatable relative to the cabinet, and the cylinder and the rod are fixed to the connector.

7. The vending machine of claim 6, wherein the rod and the cylinder are located at opposite sides of the connector.

8. The vending machine of claim 7, wherein the connector comprises a locating portion and a fixing portion, the cylinder is fixed to the fixing portion, and the rod extends through the locating portion and is extensive relative to the cylinder.

9. A door pull assembly mounted to a cabinet and a door, the door being rotatable relative to the cabinet, the door pull assembly comprising:
a bar mounted to the door; and
a puller comprising a cylinder and a rod, the cylinder fixed to the cabinet, a joint attached to one end of the rod, and the joint slidable on the bar,
wherein the cylinder is configured to draw the rod, and the rod is configured to pull the door relative to the cabinet.

10. The door pull assembly of claim 9, wherein the joint comprises a slider and a rotator, the slider is slidably attached to the bar, the rotator is pivotable relative to the slider, and the rod is mounted to the rotator.

11. The door pull assembly of claim 10, wherein the rotator is attached to the slider through a fastener, and the rotator is pivotable about the fastener.

12. The door pull assembly of claim 9, wherein the bar is fixed to the door through two bar holders, and the bar is spaced and substantially parallel to the door.

13. The door pull assembly of claim 9, wherein a plane defined by the rod and the bar is substantially perpendicular to the door.

14. The door pull assembly of claim 9, wherein a connector is fixed and rotatable relative to the cabinet, and the cylinder and the rod are fixed to the connector.

15. The door pull assembly of claim 14, wherein the rod and the cylinder are located at opposite sides of the connector.

16. The door pull assembly of claim 15, wherein the connector comprises a locating portion and a fixing portion, the cylinder is fixed to the fixing portion, and the rod extends through the locating portion and is extensive relative to the cylinder.
